(19) United States
(12) Patent Application Publication
(10) Pub. No.: US 2012/0253985 A1
(43) Pub. Date: Oct. 4, 2012

(54) METHOD AND SYSTEM FOR EXTRACTION AND ACCUMULATION OF SHOPPING DATA

(75) Inventors: Guillaume Maron, Paris (FR); Damien Rajon, Paris (FR); Jean Guillou, Paris (FR)

(73) Assignee: Kwift SAS, Puteaux (FR)

(21) Appl. No.: 13/113,995

(22) Filed: May 23, 2011

(30) Foreign Application Priority Data
Nov. 8, 2010 (FR) 10/04360
Nov. 8, 2010 (FR) 10/04361

(51) Int. Cl. G06Q 30/06

(52) U.S. Cl. 705/27.1

(57) ABSTRACT

A method for shopping cart validation automation, comprising analyzing a webpage to determine if it contains a shopping cart structure and if the user has expressed desire to initiate a checkout procedure, extracting shopping cart and other price elements from pages of a checkout tunnel, accumulating such information for the shopping transaction, validating the shopping transaction using the accumulated information, and allowing the user to confirm or cancel the transaction upon validation. Alternatively, the method may message the use that the transaction is not reconcilable where the shopping cart could not be validated. Also, the system can advantageously build a history database storing transactional details, including screen shots of pages of the checkout tunnel.

### CROSS-REFERENCE TO RELATED APPLICATIONS

This application is a Nonprovisional Patent Application claiming benefit under 35 USC § 119(a) of the following applications, each naming Guillaume Maron, Jean Guillou, and Alexis Fogel:

French Patent Application No. 10/04360, filed Nov. 8, 2010, with the title “Méthode et système d'exécution informatisée de tâches sur Internet”, and

French Patent Application No. 10/04361, filed on Nov. 8, 2010, with the title “Procédé et système informatisée d'achat sur le web”.

Each application cited above is hereby incorporated by reference for all purposes. The present disclosure also incorporates by reference, as is set forth in full in this document, for all purposes, the following commonly assigned applications/patents:

U.S. patent application Ser. No. ______ [Attorney Docket No. 93180-800064] filed of even date herewith and entitled “METHOD AND COMPUTER SYSTEM FOR PURCHASE ON THE WEB” naming Fogel, et al. (hereinafter “Fogel I”);

U.S. patent application Ser. No. ______ [Attorney Docket No. 93180-800065] filed of even date herewith and entitled “TASK AUTOMATION FOR UNFORMATTED TASKS DETERMINED BY USER INTERFACE PRESENTATION FORMATS” naming Fogel, et al. (hereinafter “Fogel II”);

U.S. patent application Ser. No. ______ [Attorney Docket No. 93180-800066] filed of even date herewith and entitled “ANTHROPOMIMETIC ANALYSIS ENGINE FOR ANALYZING ONLINE FORMS TO DETERMINE USER VIEW-BASED WEB PAGE SEMANTICS” naming Fogel, et al. (hereinafter “Fogel III”).

### BACKGROUND

The present invention relates to generally the field of electronic commerce and more particularly to methods and apparatus for validating data stored as part of an electronic shopping cart in automated or assisted methods of online purchasing and a system implementing the method.

Due to the growth, popularity and usefulness of the Internet, a great many transactions are now undertaken using the Internet, typically in the form of user manual interactions with web pages. In a typical operation, a user's browser makes a request to a web server, the web server returns the requested page, wherein the requested page includes form fields, buttons, images and/or other user input elements. When the user's browser receives the requested web page, typically in the form of data encoded using the HTML protocol, the browser considers user preferences and device capabilities, and renders the requested page, presents a view of that page to the user in a browser window and waits for the user to input data into the form fields or otherwise interact with the web page elements.

These methods can be used for online transactions, shopping, browsing, reserving, etc. (generally falling into a category often referred to as “e-commerce”). For example, the user might visit a website (i.e., cause his or her browser to retrieve a webpage that is part of a collection of static or dynamic web pages collectively referred to, possibly along with associated data structures, a “website”), view products for sale, indicate selections, provide purchase instructions and details, etc. by interacting with web page elements.

Another approach for e-commerce is to provide a computer-to-computer interface, such as an application program interface, or “API”, that would allow one computer or computer process to programmatically provide specifications and details of a requested e-commerce transaction. More typically, vendors only provide a web interface with pages designed for human user interaction.

When a purchasing process involves multiple web pages and actions, it is often not possible to simply extract all of the purchasing information from one page. There might be a page for listing the order, another page for confirming shipping details, and so on. To keep track of it all, the user can print each page out, or perhaps some vendors provide summary pages, but not all do. Even with such pages, if a user desires to maintain structured data about purchases, it often might require that the user print web pages and retype all the information about purchases.

One common online purchase model is one based on building a shopping cart in which items are virtually placed. These items are then validated upon user expression of checkout or desire to consummate the purchase. Validation requires specification of consumers' personal data, including shipping address, billing address and other characteristics of payment methods. Finally, the transaction is completed after going through the validation pages and the user's confirmation of the purchase order.

Studies have shown that more than half of the acts of shopping on the Web are not completed, consumers abandoning the procedure due to the complexity of steps required to finalize the purchase act, which involves the supplying of shipping, billing, etc. information (and therefore having to go and search fro that information if it is not memorized). In addition, with each execution of a purchase act, such sensitive personal information is transmitted over the network and may be intercepted and decoded, by using for example spyware, which stores the user's keystrokes.

Solutions have been devised to make it easier for consumers to purchase products online. For example, U.S. Pat. No. 5,960,411 describes storing data on the vendor's server, but that is specific to the particular merchant website and users typically would prefer the flexibility of tools that can be used at any merchant site.

Thus, it is desirable to provide solutions that facilitate automation in online purchasing, in a site-independent fashion that automate validation of items in a shopping cart and other elements associated with the purchase.

### BRIEF SUMMARY

In embodiments of a purchasing management system, software, hardware or other computerized implementation provides functionality that operates in conjunction with a user using a computer, telephone, or other computing and network-connected device to handle shopping transactions. A shopping transaction might involve browsing offerings, making a series of selections, reviewing selections and then performing check-out actions. The purchasing management system automates validation of a shopping cart data structure and/or online purchasing transaction. In some embodiments, a software-based shopping cart analysis program runs in the background on the user's device and is triggered when there is an indication of a desire to consummate a shopping transaction, such as when the user explicitly indicates a request to complete the transaction or where the program can infer that the user is completing the transaction. Once triggered, shopping cart analysis program can analyze a current webpage being viewed by the user, but also determine the possible navigation steps to get to a transaction conclusion, while obtaining information about the transaction. The web pages that form the checkout process are referred to herein as a “checkout tunnel” akin to the checkout aisle in a supermarket that a purchaser would enter in a physical store once a shopping cart is loaded with items of interest.

The shopping cart analysis program analyzes each page of a checkout tunnel, extracting shopping cart elements, as well as any other price elements and details needed to obtain data about the pending transaction. Examples of such elements include product ID, unit quantity for that product ID, price per unit, extended price (i.e., the price for the selected unit quantity), applicable taxes, shipping fees, insurance fees, and so on. When such elements are extracted and understood, the shopping cart analysis program is able to perform a number of useful actions, such as validating the contents of the shopping cart and the associated charges, storing transaction details for later use by the user, etc.

In some embodiments, the analysis of a web page is done using a rule-based system that works on the document object model (“DOM”) of the web page. In some embodiments, the information is extracted and accumulated from the shopping pages is stored in a history database for later review by users of the system. This then can serve as a transaction history database, independent of any merchant website formatting.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a simplified block diagram of one embodiment of a networked, Internet client server system.

FIG. 2 is a simplified block diagram of one embodiment of an Internet client machine, running components of the system described herein.

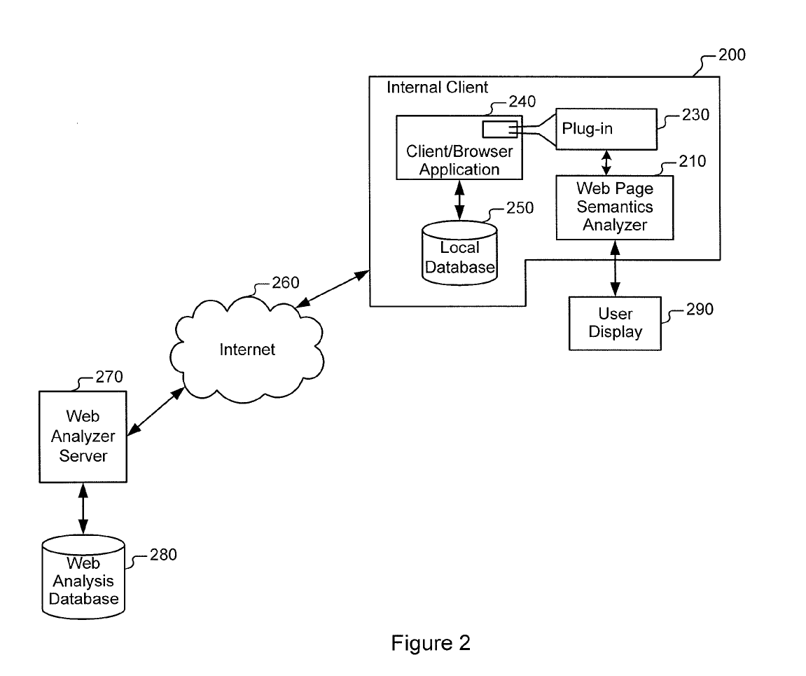

FIG. 3 illustrates steps of the shopping cart validation procedure according to one embodiment.

FIG. 4 illustrates one embodiment of components of a shopping cart validation system.

FIG. 5 is a screenshot of one example of a shopping cart item.

### DETAILED DESCRIPTION

As explained herein, methods, systems and apparatus are provided to automate shopping cart validation (e.g., validating items in a shopping cart and all other associated price values for the transaction) in a site-independent fashion. In some aspects, the validation is achieved by extracting and accumulating product, quantity, price elements of a shopping cart and other elements of a purchasing transaction. Advantageously, the information can be stored for a historical review of shopping transactions. While the web pages might be provided over one or more different types of networks, such as the Internet, and might be used in many different scenarios, many of the examples herein will be explained with reference to a specific use, that of a user interacting with web pages from an e-commerce web site, with user interactions including purchase selection, checkout tunnel pages, confirmation of purchase details (e.g., totals, shipping, etc.) as well as storing such pages and associated transactional information, and doing so in an automated manner where appropriate.

Those skilled in the art will appreciate that logic used to automate shopping cart validation and purchasing transaction validation have many applications and that improvements inspired by one application have broad utility in diverse applications that employ techniques used to automate shopping cart and purchasing price validations.

Below, example hardware is described that might be used to implement aspects of the present invention, followed by a description of software elements.

### Network Client Server Overview

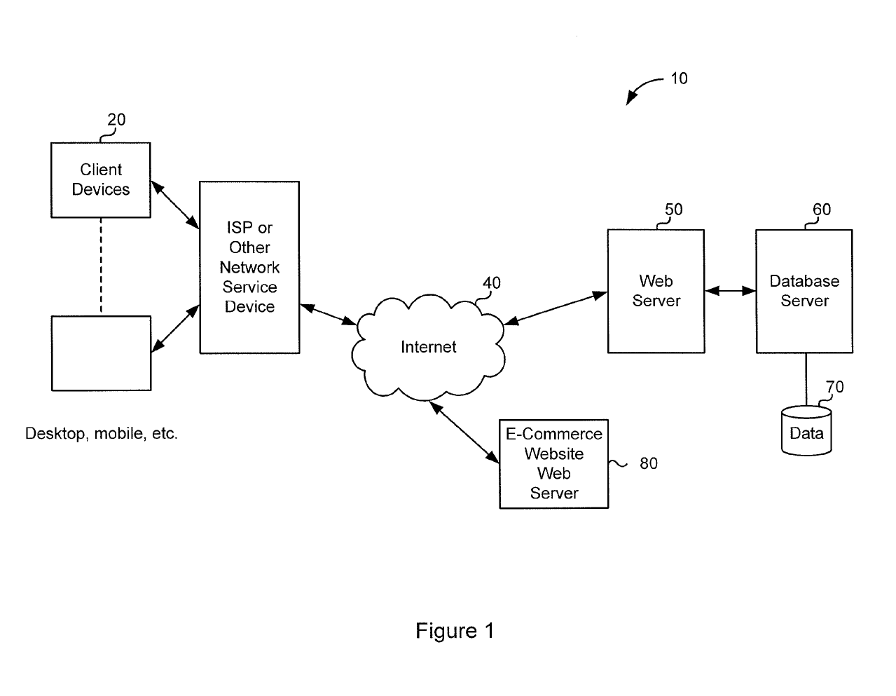

FIG. 1 is a simplified functional block diagram of an embodiment of an interaction system 10 in which embodiments of the shopping data extraction and accumulation system described herein may be implemented. Interaction system 10 is shown and described in the context of web-based applications configured on client and server apparatus coupled to a network (in this example, the Internet 40). However, the system described here is used only as an example of one such system into which embodiments disclosed herein may be implemented. The various shopping data extraction and accumulation components described herein can also be implemented in other systems.

Interaction system 10 may include one or more clients 20. For example, a desktop web browser client 20 may be coupled to Internet 40 via a network gateway. In one embodiment, the network gateway can be provided by Internet service provider (ISP) hardware 80 coupled to Internet 40. In one embodiment, the network protocol used by clients is a TCP/IP based protocol, such as HTTP. These clients can then communicate with web servers and other destination devices coupled to Internet 40.

An e-commerce web server 80, hosting an e-commerce website, can also be coupled to Internet 40. E-commerce web server 80 is often connected to the internet via an ISP. Client 20 can communicate with e-commerce web server 80 via its connectivity to Internet 40. E-commerce web server 80 can be one or more computer servers, load-balanced to provide scalability and fail-over capabilities to clients accessing it.

A web server 50 can also be coupled to Internet 40. Web server 50 is often connected to the internet via an ISP. Client 20 can communicate with web server 50 via its connectivity to Internet 40. Web server 50 can be configured to provide a network interface to program logic and information accessible via a database server 60. Web server 50 can be one or more computer servers, load-balanced to provide scalability and fail-over capabilities to clients accessing it.

In one embodiment, web server 50 houses parts of the program logic that implements the shopping data extraction and accumulation system described herein. For example, it might allow for downloading of software components, e.g., client-side plug-ins and other applications required for the systems described herein, and synching data between the clients running such a system and associated server components.

Web server 50 in turn can communicate with database server 60 that can be configured to access data 70. Database server 60 and data 70 can also comprise a set of servers, load-balanced to meet scalability and fail-over requirements of systems they provide data to. They may reside on web server 50 or on physically separate servers. Database server 60 can be configured to facilitate the retrieval of data 70. For example, database server 60 can retrieve data for the shopping data extraction and accumulation system described herein and forward it to clients communicating with web server 50. Alternatively, it may retrieve transactional data for the associated merchant websites hosted by web server 50 and forward those transactions to the requesting clients.

One of the clients 20 can include a desktop personal computer, workstation, laptop, personal digital assistant (PDA), cell phone, or any WAP-enabled device or any other computing device capable of interfacing directly or indirectly to Internet 40. Web client 20 might typically run a network interface application, which can be, for example, a browsing program such as Microsoft's Internet Explorer™, Netscape Navigator™ browser, Mozilla's firefox™ browser, Opera's browser, or a WAP-enabled browser executing on a cell phone, PDA, other wireless device, or the like. The network interface application can allow a user of web client 20 to access, process and view information and documents available to it from servers in the system, such as web server 50.

Web client 20 also typically includes one or more user interface devices, such as a keyboard, a mouse, touch screen, pen or the like, for interacting with a graphical user interface (GUI) provided by the browser on a display (e.g., monitor screen, LCD display, etc.), in conjunction with pages, forms and other information provided by servers. Although the system is described in conjunction with the Internet, it should be understood that other networks can be used instead of or in addition to the Internet, such as an intranet, an extranet, a virtual private network (VPN), a non-TCP/IP based network, any LAN or WAN or the like.

According to one embodiment, web client 20 and all of its components are operator configurable using an application including computer code run using a central processing unit such as an Intel Pentium™ processor, an AMD Athlon™ processor, or the like or multiple processors. Computer code for operating and configuring client system 20 to communicate, process and display data and media content as described herein is preferably downloaded and stored on a processor readable storage medium, such as a hard disk, but the entire program code, or portions thereof, may also be stored in any other volatile or non-volatile memory medium or device as is well known, such as a ROM or RAM, or provided on any media capable of storing program code, such as a compact disk (CD) medium, a digital versatile disk (DVD) medium, a floppy disk, and the like. Additionally, the entire program code, or portions thereof, may be transmitted and downloaded from a software source, e.g., from one of the servers over the Internet, or transmitted over any other network connection (e.g., extranet, VPN, LAN, or other conventional networks) using any communication medium and protocols (e.g., TCP/IP, HTTP, HTTPS, FTP, Ethernet, or other media and protocols).

It should be appreciated that computer code for implementing aspects of the present disclosure can be C, C++, HTML, XML, Java, JavaScript, etc. code, or any other suitable scripting language (e.g., VBScript), or any other suitable programming language that can be executed on a client or server or compiled to execute on a client or server.

### Shopping Data Extraction and Accumulation Overview

In various embodiments, methods and systems are provided that facilitate online shopping automation. In some aspects automation of online shopping can be made easier by gaining an understanding of what is being purchased (e.g., product, quantity, and price), along with any other monetary figures associated with the transaction (e.g., shipping fees, taxes, insurance purchased, etc.). Such information, once extracted from shopping pages and accumulated for a transaction, can then be used to validate the transaction on behalf of a user. The validation can include accounting considerations such as matching against the transaction total provided by a merchant website, matching the total prices per product item, verifying the selected shipping costs, taxes incurred, etc. Once such an accounting record is built for a transaction, it can further provide a means for the user to verify transactional details either before the purchase or subsequently for managing the history of a user's purchasing transactions.

In certain aspects, once it is determined that the user has initiated a purchasing transaction (e.g., by pressing the “checkout” button), indicating that the user is entering a checkout tunnel (i.e., the sequence of pages a user walks through in order to complete a purchasing transaction), the shopping cart validation procedure is triggered. For example, all pages of the shopping sequence may be analyzed for a shopping cart structure and for any other monetary elements of the page. The analysis can then facilitate extracting any updated shopping cart information and any other monetary figures, along with their associated meaning The shopping cart structure may provide information as to the product, quantity, and price of items that the user wants to purchase. Other monetary figures, may represent other possible costs of a shopping transaction (e.g., shipping price, tax, recycling fee, insurance amount, etc.). This extracted information can then serve to validate the transaction and to be stored for historical transactional detail purposes.

In one embodiment, the shopping cart analysis engine comprises of three steps. In step one, the engine determines if there is a shopping cart structure present on a user-navigated page and that the user has expressed desire to initiate a shopping transaction (e.g., by pressing checkout), thereby indicating that the user has entered a checkout tunnel. In step two, each page of the checkout tunnel is analyzed to study the elements of the shopping cart (if any on that page) and other monetary or price elements of the page, thereby extracting and accumulating all known monetary information pertaining to the purchasing transaction. Finally, in step three the above information is used to validate a purchase (e.g., validate the total price, etc.).

In one aspect, a user-navigated page is analyzed to determine if it is a shopping cart page by searching the page for a data structure representing a shopping cart (e.g., a data structure holding information about products, unit prices, and total price). For example, the data structure can be an HTML table element (e.g., <table> tab) with rows (e.g., with <tr> tags) and columns (e.g., with the <td> tags). The structure need not confine itself to the above example, rather can be any sort of data structure maintaining shopping cart information. In one embodiment, this analysis is done using a bottom-up approach, looking first at the “cell” level, then “rows”, and then “columns”. In one embodiment, analysis to determine if a page has a shopping cart structure or shopping cart form may use the webpage analyzer system described in Fogel III.

In another embodiment, in addition to the bottom-up approach, information contained in a cell, row, table, headers, etc. may be further used to determine meaning of elements. So in one case, at the cell-level, only the text contained in the cell is used to find out which information it contains, and at the row-level the information found in each cell of the row is used to refine the meaning of the cell. For example, if two unidentified cells of price type are found, and one cell is found to be the quantity cell of the same row, then the two unidentified price cells can be resolved as the first representing the unit price, and the second representing the quantity times the unit price. Furthermore, table-level information may be used to refine the information even further by using the headers of the table columns. For example, if there's a cell with the text “Product description”, it can help understand the information found for all cells under such a header cell (i.e., same column), as being a product description cell for all rows in the table under the column with that header cell.

In one embodiment, when dealing with uncommon/complex pages, there's a parallel system which converts the website's page into more comprehensible structure. This is done specifically on each site, where an operator points out where each piece of information (e.g., product, quantity, unit price, etc.) is on the page, using for example XPATH paths. This information is then stored in a program database, which is shipped with each version of the system.

In one aspect, the meaning of price elements is derived by taking into account their context, e.g., by studying the surrounding text and images (perhaps taking into account any associated tooltips, alternate text, text on the image, etc.). As one example, a dollar figure preceded by the word “tax” within a certain range around the money symbol (e.g., for dollars, euro, pounds, etc.), may lead to the determination that the figure is a tax applicable to the transaction. Some examples of price elements and their associated meaning include: total price of a cart, delivery price, price for warranty (or insurance), discount prices, recycling fees, taxes, and a general price category that does not match any other price.

In one embodiment, the meaning for price elements is determined using a rules based engine working on the DOM structure of a user-navigated webpage. One example of a rules-based engine is described in Fogel III. The application also describes a rules tool that may be used to provide rules for the engine. As one skilled in the art can appreciate, the disclosure described herein may use all or parts of the rules-based engine described in Fogel III.

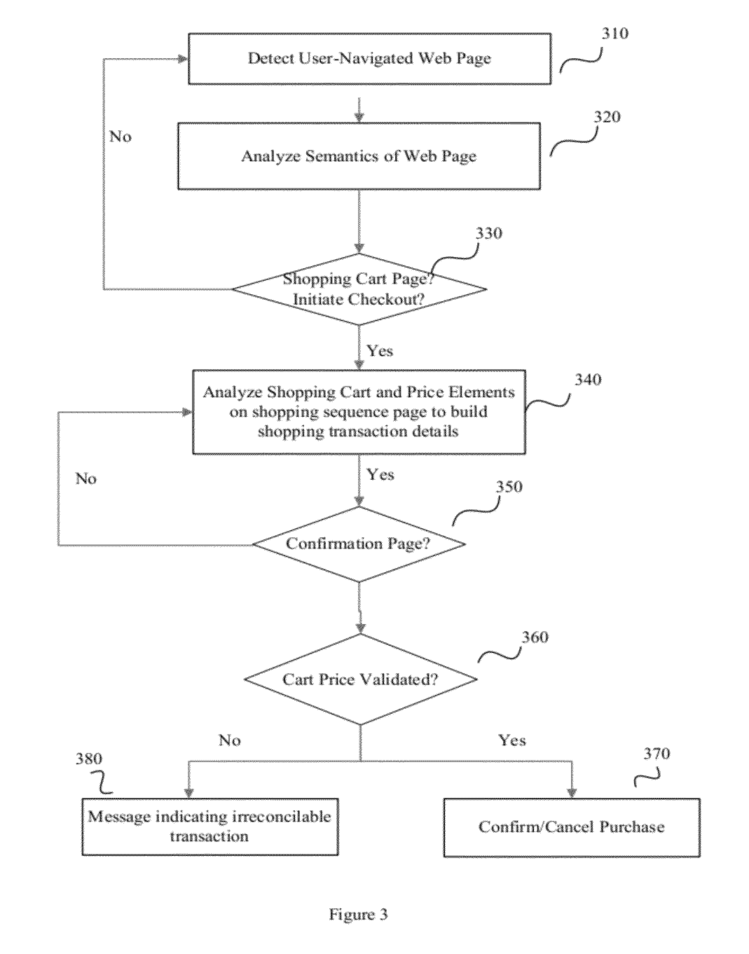

FIG. 3 illustrates steps of the shopping cart validation procedure according to one embodiment. At step 310 a user-navigated webpage is detected. At step 320 the page is analyzed for its meaning (e.g., using the forms analysis described in Fogel III), and if a cart form type is found then an analysis is triggered. Step 330 checks to see if a user has started a checkout process (e.g., by monitoring whether or not a user clicks on a checkout button). If no, then the flow is re-directed to step 310 to wait for the next user-navigated webpage. If the user has started a checkout procedure, step 340 will do the analysis of all shopping cart and any other price elements present on the page to build details of the shopping cart transaction.

The above analysis will be done for each page in the checkout tunnel until a confirmation page is reached. So, at step 350 a check will be performed to see if the user has reached the confirmation page. If not, then the flow will loop back to step 340 to continue the analysis for shopping cart and price elements while the automated checkout procedure continues to the next page in the shopping tunnel sequence of pages.

If on the other hand, the confirmation page is reached, then at step 360 the cart price will be validated. For example, the system will check to see if the total matches the sum of the price times the quantity of all items in the cart, plus a combination of all other prices found during the checkout tunnel (shipping fee, insurance, recycling fee, etc.). In one embodiment, the system starts by trying trivial solutions. One such check could be to see if the product costs plus shipping fee found equals the total price, using only prices found on the final or confirmation page of the tunnel. If the simple solution does not validate the total price of the transaction, then the system may go on to try more complex combinations in an iterative process. For example, it may check if the product costs, plus one or more taxes, plus one or more shipping fees, plus one or more discounts equal the total cost of the transaction, using prices found throughout the checkout tunnel, and in an iterative fashion (i.e., first try adding in taxes, then try adding in shipping fees, then try adding in discounts, and so on).

Finally if the processing at step 360 leads to the validation of the shopping cart and underlying transaction, then at step 370 the user can either confirm or cancel the transaction. In one embodiment, the user will be able to review all the shopping cart transaction details accumulated during the steps described above before confirming or cancelling the transaction. If step 360 was not able to reconcile the transaction (i.e., could not figure out the price figures that lead to the total presented for the transaction), then in one aspect a message indicating that the transaction was not reconcilable will be presented to the user. In one case, the user can then decide to proceed in a manual fashion to either complete or abandon the transaction.

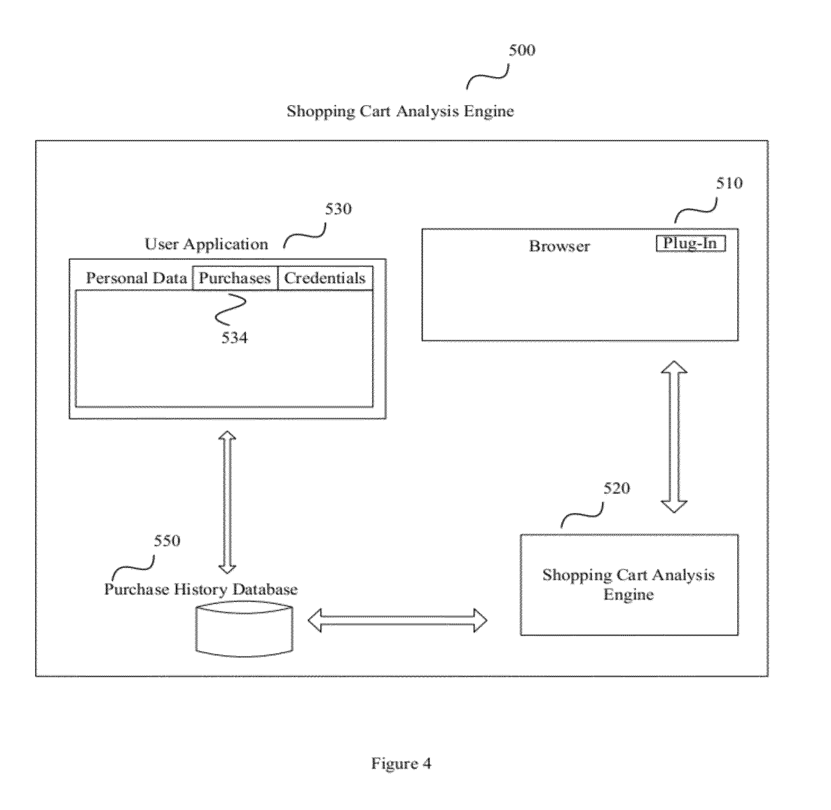

FIG. 4 illustrates one embodiment of components of a shopping cart validation system 500. It comprises of a browser plug-in 510, a shopping car analysis engine 520, a user application 530 and a purchase history database 550. When a user navigates on a webpage of a website, plug-in 510 will forward the DOM information to component 520. At that point, control will be passed over to component 520 to analyze the page for shopping cart and other price elements, thereby determining if the page is at the beginning of a checkout tunnel, and whether the user has initiated the checkout process. In one embodiment, component 520 will use the web page analyzer system described in Fogel III. Component 520 may also write some details per page it analyzes to the history database 550. Alternatively, it may keep analysis details per page in a local memory and write to the history database 550 upon the completion of analysis of all pages of the checkout tunnel sequence of pages. The information stored in the purchase history database may include screen shots of the various pages of the checkout tunnel.

The shopping cart analysis engine 520 may, after its analysis, update the user-navigated webpage (e.g., by pre-filling information on the page and by taking a macroscopic action on the page on behalf of the user). More details on auto-execution of a page can be found in Fogel I and Fogel III. This process may repeat until a shopping confirmation page is reached. Engine 520 will continue to extract and accumulate information about the shopping pages for a transaction. In one embodiment, when the page is determined to be a confirmation page, then details of the transaction, accumulated during the analysis will be stored to the purchase history database. The details may include screen shots of the web pages of the checkout tunnel.

In one aspect, once engine 520 determines that a confirmation page has been reached, it can start the shopping cart validation procedure described in FIG. 3, step 360. As one possibility, the engine will use all discovered price elements and cart items to sum them up to match against the total on the confirmation page. If the engine is able to reconcile the transaction totals, it can render a confirmation page for the user, with item-by-item details for user review, before confirming or cancelling the transaction. Engine 520 may instead be unable to reconcile the transaction. In that case, it can provide a message indicating that the transaction was irreconcilable to the user. The user may at that point continue manually on the merchant website to proceed in whatever manner chosen by the user.

FIG. 4 also provides a user interface component 530. User application 530 interacts with purchase history database 550 to provide transaction details to the user. In this way, a user can keep track of history details across a host of merchant websites from where shopping purchases have been conducted. Advantageously, the history database is populated with screen shots of the pages analyzed during the shopping cart validation process.

One skilled in the art will appreciated that FIG. 4 is one implementation of the disclosure described herein. However, these components may execute their logic in a more or less distributed fashion. For example, the functionality described as being implemented by plug-in 510 and shopping cart analysis engine 520 may be executed by a myriad of executables or be executed by one component in its entirety. Also, database component 550 can reside locally, remotely, both and maybe distributed across a host of physical servers.

Shopping Cart Analysis Example

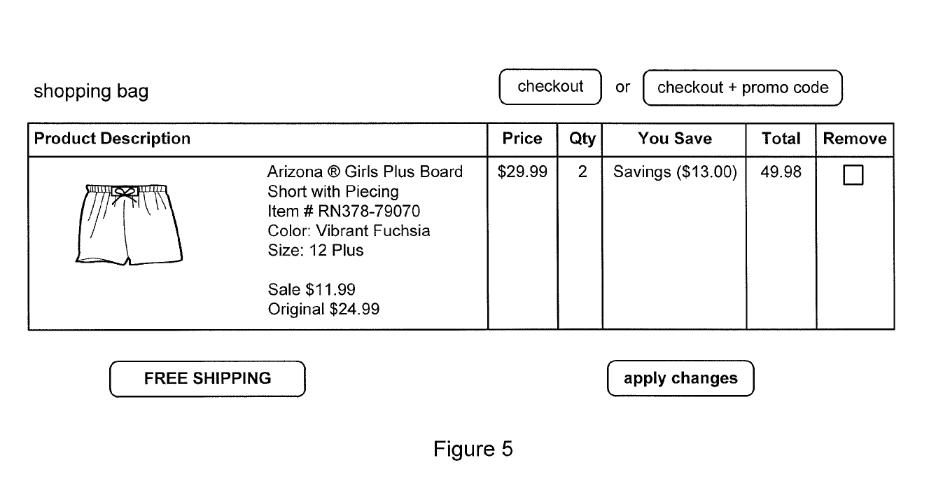

FIG. 5 is an illustration of a shopping cart with a product item, with price, etc. In the below example, the bottom-up approach as applied to FIG. 5 is detailed below.

First perform Cell analysis: first browse each cell, matching its text with the defined rules, e.g., the top left “cell” in FIG. 5 contains the text: “Product description”, so this cell is tagged with the “PRODUCT_DESCRIPTION_HEADER” information type, and continue this process for each cell of that table, providing the following understanding for each cell types data:

PRODUCT_DESCRIPTION_HEADER|PRODUCT_PRICE_HEADER|QUANTITY_HEADER|NOTHING|TOTAL_PRICE_HEADER|NOTHING NOTHING|UNKNOWN_PRICE|QUANTITY|UNKNOWN PRICE|UNKNOWN PRICE|NOTHING.

Then perform Row analysis: Use the information found for each cell of the same row and try to refine their meaning In this example, use all the unknown prices found and the quantity and try to match them together to find out which one is the total product price (unit price times the quantity), and which one is the unit price by trying all the possible combinations. This would help in determining the two price types, leaving unclear the meaning of the cell with the text “Arizona Girls Plus Board Short . . . ”.

Finally perform Column/table column header analysis: Use the information found in the top cell of each column, to refine the information of the cells underneath. In this example, it can be inferred that the “Arizona Girls Plus Board Short . . . ” cell contains information of type PRODUCT_DESCRIPTION because its “header-cell” contains the information PRODUCT_DESCRIPTION_HEADER.

In one industrial application, the method of the invention can be implemented by programming an internet browser plug-in, which the consumer has installed on a multimedia terminal that can connect to the Internet, such as a computer or mobile phone. In addition, the inventive system may use a physical object having electronic storage capabilities that can incorporating a data storage medium on which the database of personal consumer information and/or the database of purchase history are maintained, separate from the client device used, as might be done when the client device is a shared device shared among multiple consumers desiring to keep their information separate.

Aspects of the invention can be implemented in software running on the client computer, and possibly elsewhere. Aspects of the invention might also be implemented in hardware or implemented by program code on computer-readable media that, when executed by hardware, performs the programmed aspects. As one example, the program code might be provided over a network in downloadable form that can be executed by a user at a client computer to implement various aspects of the invention.

As explained above, the user might be a consumer making purchases by interacting with web pages of different websites. A downloaded program or programs can include a plug-in that takes actions as if it were the user taking actions, as well as storing and/or recording information that is presented to the user. In this manner, the system can assist with purchase processes, and can do so without requiring advance notice of the structure of the web pages that the vendors use and without requiring a formalized computer-to-computer interface.

The client device is a computer, computing device, smart phone, etc. that has the ability to run programs, display information to a user and accept user input. Typically, the display is a screen. Typically, the client device has some network connection, wired or wireless. The client device has computing capability, such as a processor that executes sets of instructions, and storage for the program code comprising the sets of instructions. In particular embodiments, there is storage for user data, such as a user database (which can be structured, unstructured, textual, binary, etc.) that contains user data (name, credit card numbers, addresses, purchase history, etc.) often in an encrypted form. The client device is able to read and write to such storage, referred to herein as the “user database” although it should be understood that specific database structures are not required. In some cases, there are multiple databases, such as a user details database and a purchase history database, but it should be apparent that different storage structures are possible.

In some cases, the data and/or program instructions are stored on physical medium separate from the client device and is provided with security means and means of communication with the multimedia device. For example, the security means might be a biometric reader that authenticates the consumer/user, for example, using fingerprint recognition. The interface might be a conventional USB or Bluetooth™ connection. This variant involving a physical medium allows consumers to make their purchases from any multimedia device while securing access to personal data and allowing access and preservation of purchase history, independent of the client device used. This would be useful where the user is using a shared computer.

The present invention is not limited to the preferred embodiment and implementation described, and may be modified or adapted to the needs or requirements, without departing from the scope of the invention.

What is claimed is:

1. A method for extracting and accumulating shopping data the method comprising:
receiving a user-navigated webpage for a purchasing transaction;
analyzing the webpage for purchasing elements;
extracting the value for elements determined to be purchasing element, along with their meaning; and
storing the extracted information into a transaction details record.

2. The method of claim 1, further comprising repeating the receiving, analyzing, extracting and storing until a purchasing confirmation page is reached.

3. The method of claim 2, further comprising validating the purchasing transaction by comparing the transaction details record with the confirmation page details.

4. The method of claim 3, further comprising presenting a display to the user for either confirming or cancelling the transaction where the purchasing transaction was validated.

5. The method of claim 3, further comprising presenting a display to the user indicating irreconcilable purchasing transaction where the validation of the purchase transaction was not possible.

6. The method of claim 1, further comprising storing the transaction details record into a database.
